(19) United States
(12) Patent Application Publication
(10) Pub. No.: US 2013/0080343 A1
(43) Pub. Date: Mar. 28, 2013

(54) Real estate freed from immobilization

(71) Applicants: William S. Kam, Pittsburgh, PA (US); Carol E. Brown, Pittsburgh, PA (US)

(72) Inventors: William S. Kam, Pittsburgh, PA (US); Carol E. Brown, Pittsburgh, PA (US)

(21) Appl. No.: 13/200,203

(22) Filed: Sep. 22, 2011

(51) Int. Cl. G06Q 50/16; G06Q 40/00

(52) U.S. Cl. 705/313

(57) ABSTRACT

The subject of this petition for letters patent is a business patent. Patentable subject matter is identified in Article I Section 8 of the federal constitution. Business patentable matter referenced herein is invention conductive to promotion of Progress of Science. The invention shows how to structure existing rules of record keeping procedure so as to free real estate from being made idle and immobilized by a mortgage lender. The lender has filed a foreclosure court action and subsequently does not complete taking title. That leaves an impoverished borrower with no equity motivation or personal financial resources but obligated to local government for property maintenance. The mortgage lending banks act in violation of antitrust laws prohibiting restraint of trade. Filing a deed in lieu of foreclosure is the key to freeing immobilized property.

### BRIEF SUMMARY OF THE INVENTION

This writing is for a business patent issued in conformity to the United States Constitution Article I, Section 8. Invention is new and useful.

The new circumstance is the Wall Street creation of bundling promissory note mortgage debt into common stock certificates. The original tangible paper notes have been physically lost in the shuffle. The statute against frauds has been violated in failure of recording requirement when pretending to have passed real estate secured debt. Our invention brings new relief to this new finance security creation problem.

### BRIEF DESCRIPTION OF THE VIEWS OF THE DRAWING

FIGS. 1 through 4 are a series of numbered rectangles. The rectangle labels show the sequence of activities necessary to free partly foreclosed real estate from being an immobilized object of commerce. FIG. 4 represents filing of a deed in lieu of foreclosure.

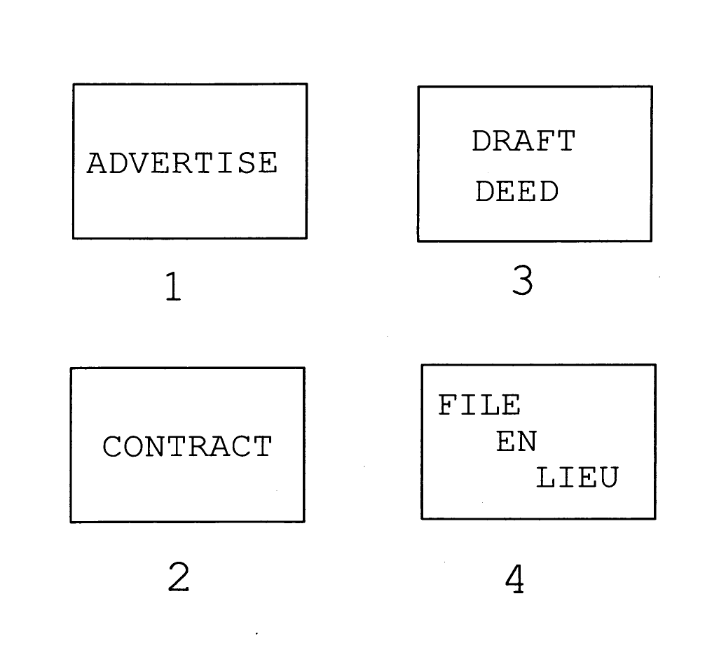

### BACKGROUND OF THE INVENTION

Human cooperation in commercial activity is inherently cyclical in intensity. Concurrent is a necessity of land usage in commerce activity. Valuation of land then cycles accordingly with usage intensity. A banking system maintaining a monetary exchange system straddles a network of financially long and short positions.

Financial madness is historic. Each mania is unique in details and unique in resolution. Tulip bulb mania and South Sea Bubble are memorable. Kruger Toll is a mania label from the Wall Street existence period. The same madness has finally reached the mortgage paper market. Our invention brings new relief to a new problem pattern.

### OBJECT OF INVENTION

An object of the present invention is to establish a patent protected monopoly of operating a business that functions to release ownership of financially distressed real estate from ownership of record to lien holders who have filed court foreclosure proceeding and have abandoned subsequently completion of foreclosure leaving borrower of status as owner of record responsible for property maintenance but without any equity usage in the property.

A second object is to bring under government management the confused business mess created by voluminous conversion of mortgage promissory notes into backing for common stock certificates with attendant loss of track of paper required by the statutes of frauds.

### DETAILED DESCRIPTION OF THE DRAWINGS

The drawing figures show a series of part numbered blocks enclosing function performance labels. The blocks show the occurrence of a chronological event series that involves filing a deed in lieu of foreclosure. The deed places in the public record full ownership with the mortgage lender. The statute of frauds paper recording requirement stops the record with the lender. Lender real estate ownership record does not pass with transfer of stock certificates. However claim entitlement does pass with now lost promissory note paper.

The lender as a sub prime lender had an insurer. At some discounted price level there is a market for such property. It is to government advantage to have occupied, tax paying property. The extreme distress situation can be relieved by recording a deed in lieu of foreclosure.

Inventor Brown has raised the question of possible federal income tax consequence of forgiveness of the mortgage promissory loan note. This petition for patent claims includes a clause in the deed that lender will not pursue collection of deficiency on the loan. Typically the loan paper has been lost in the process of transferring the asset into form of a Wall Street common stock certificate. The lending bank has been paid off by government insurance. The bank lacks standing to prove ownership of any debt paper. The deed paper of category deed in lieu of foreclosure is useful in protecting the displaced former house occupant. Also the deed paper of category deed in lieu of foreclosure is useful in protecting the municipality community by forcing the bank to act. The patent sought claim is a claim to a business monopoly. The deed in lieu is useful in supporting formation of an organization competent to implement a new solution to a perplexing immobilization of home real estate.

### RESTRAINT OF TRADE AND CLASS ACTION

The problem is unique and the invention solution is unique, viz.: new and useful. Banks are engaged in conspiracy in unlawful restraint of trade. Bank branches and personnel have immobilized trade in many real estate units.

The wrong invites protective reaction by a class. The correction does not require the classic court class action. Each injury is of sufficient magnitude to merit individual attention, Coordination effort is offered by a patent. Patent is an exclusive right to operate a franchise that assembles related record processing and issues instruction guiding filing deed in lieu of foreclosure. The monopoly process produces tangible results.

### BUSINESS PROCESS TANGIBLE PRODUCT

Current developments in computer software patenting raise anew scrutiny of historic Patent 500,071; Hotel Security Co. v/Lorraine Co., 160 Fed. 467 (CCAC-2, 1908). Regarding the instant petition for letters patent it would seem that a patent should be granted and leave question of enforceability to the judiciary branch of the government.

Real estate immobilized has experienced tangible change. The municipality demolishes the abandoned residence. Land with a building structure is tangibly different from a plowed over residue of a basement excavation.

The patent monopoly sought becomes the process controller direction of a process of variable tangible results.

We claim:

1. A patent monopoly that acts in a corporation and does advertising and delivering deed in lieu of foreclosure which deed provides to a financially distressed mortgage borrower specific rescue defense against local government harassment charging neglect of property.

2. The business practice defined in claim 1 wherein related specific advertising is an essence for implementation of the patent protected monopoly involving deed in lieu of foreclosure.

3. The business practice defined in claim 1 is sustained by computer programing defining the procedure steps of the routine of delivering service by means of deed in lieu of foreclosure.

4. The business practice defined in claim 1 wherein said deed in lieu of foreclosure has a clause stating that the deed grantee will not pursue a deficiency judgment against the grantor as an action to collect on any prior existing mortgage promissory note encumbering the real estate.

5. The business practice wherein said business practice actor drafts deed in lieu of foreclosure which deed has a clause stating that the deed grantee will not pursue a deficiency judgment against the grantor as an action to collect on any prior existing mortgage promissory note encumbering the real estate.

6. The business practice formatted as a franchise service which service instructs and keeps records assisting real estate owners faced with partial mortgage foreclosure process suspended for which suspended foreclosure the resulting injury circumstance can be relieved by a deed in lieu of foreclosure.

7. The process of drafting and recording in government real estate records a deed in lieu of foreclosure for real estate which has been immobilized of marketability and exposed to destructive material product change.
